(19) United States
(12) Patent Application Publication
(10) Pub. No.: US 2016/0261719 A1
(43) Pub. Date: Sep. 8, 2016

(54) INFORMATION PROCESSING SYSTEM, CONTROL PROGRAM, AND CONTROL METHOD

(71) Applicant: FUJITSU LIMITED, Kawasaki-shi (JP)

(72) Inventors: Yutaka Ezaki, Kawasaki (JP); Katsuo Iimura, Yokohama (JP); KENICHIROU SHIMOGAWA, Numazu (JP); Takahiro Kojima, Yokohama (JP)

(73) Assignee: FUJITSU LIMITED, Kawasaki-shi (JP)

(21) Appl. No.: 15/053,195

(22) Filed: Feb. 25, 2016

(30) Foreign Application Priority Data
Mar. 4, 2015 (JP) 2015-041922

(51) Int. Cl. H04L 29/06

(52) U.S. Cl. CPC H04L 67/42

(57) ABSTRACT

An information processing system includes a communication control device that receives an input of first process communication from a first information processing device and controls internal and external communication with a second information processing device, and a responding device that can communicate with the communication control device, wherein upon receiving the first process communication, the communication control device transmits the received first process communication to the second information processing device, and upon receiving second process communication, which is a response to the first process communication transmitted from the second information processing device to the first information processing device, the communication control device transmits the second process communication to the responding device by changing a destination of the second process communication from the first information processing device to the responding device.

### CROSS-REFERENCE TO RELATED APPLICATION

This application is based upon and claims the benefit of priority of the prior Japanese Patent Application No. 2015-041922, filed on Mar. 4, 2015, the entire contents of which are incorporated herein by reference.

### FIELD

The present invention relates to an information processing system, a control program, and a control method.

### BACKGROUND

A provider (hereinafter also referred to as a service provider) that provides an information processing service to users provides the service by operating a business system. Such a service provider is provided with a backup system (hereinafter also referred to as a standby system) capable of executing the same process as the process executed by a business system (hereinafter also referred to as an operation system) in operation. The standby system is constructed in a data center located approximately several tens of km to several hundreds of km from a data center in which an operation system is constructed, for instance. Due to this, even when it has become difficult to continuously perform processes in an operation system due to occurrence of a natural disaster, the service provider can continue providing a service to users by operating the standby system. Moreover, after the operation system is recovered, the service provider can allow the operation system to execute the processes executed by the standby system again (see, for instance, Japanese Examined Patent Application Publication No. H07-120293 and International Publication Pamphlet No. WO2012/160690).

### SUMMARY

In the standby system described above, the service provider may perform processes (development of applications, testing of operations, and the like) different from the processes executed by an operation system in a normal operation mode. Moreover, in the standby system described above, one standby system may function as the standby system of a plurality of operation systems. Thus, even when a standby system has the same hardware as an operation system, the standby system may be unable to provide the same processing performance as the processing performance of the operation system depending on the occurrence time and the extent of a natural disaster.

Thus, the service provider performs an evaluation test in advance to know whether the standby system can execute the process of an operation system in various situations. In this way, the service provider can prevent the occurrence of a situation in which the standby system cannot succeed the process of the operation system in the event of a natural disaster or the like.

When the evaluation test is performed, it is best that data (hereinafter also referred to as operation data) that is actually processed by the operation system is processed by the standby system at the same time as the operation system. However, when the operation system and the standby system operate in a synchronized manner, a communication occurs between the operation system and the standby system, which may have an adverse effect on the operation of the operation system.

According to an aspect of the embodiments, an information processing system includes a communication control device that receives an input of first process communication from a first information processing device and controls internal and external communication with a second information processing device, and a responding device that can communicate with the communication control device, wherein upon receiving the first process communication, the communication control device transmits the received first process communication to the second information processing device, and upon receiving second process communication, which is a response to the first process communication transmitted from the second information processing device to the first information processing device, the communication control device transmits the second process communication to the responding device by changing a destination of the second process communication from the first information processing device to the responding device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an entire configuration of an information processing system 100.

FIG. 2 is a diagram for describing testing of a standby system according to a comparative example.

FIG. 3 is a diagram for describing the communication control process according to the first embodiment and the configuration of the responding device and the standby system.

FIG. 4 is a diagram illustrating a hardware configuration of the information processing system 100.

FIG. 5 is a functional block diagram of the first site 10.

FIG. 6 is a functional block diagram of the second site 20 illustrated in FIG. 4.

FIG. 7 is a sequence chart illustrating an outline of the communication control process according to the first embodiment.

FIG. 8 is a diagram for describing the details of the first embodiment.

FIG. 9 is a flowchart illustrating the details of the communication control process according to the first embodiment.

FIG. 10 is a flowchart illustrating the details of the communication control process according to the first embodiment.

FIG. 11 is a flowchart illustrating the details of the communication control process according to the first embodiment.

FIG. 12 is a diagram for describing the layout of an IP header.

FIG. 13 is a diagram for describing the layout of a TCP header.

FIG. 14 is a diagram for describing a specific example of the transmission information in the first embodiment.

FIGS. 15A and 15B are diagrams for describing a specific example of the response information according to the first embodiment.

FIG. 16 is a flowchart illustrating the details of the communication control process of the communication control device 231.

FIG. 17 is a flowchart illustrating the details of the communication control process of the responding device 232.

FIG. 18 is a diagram for describing a specific example of the transmission information according to the second embodiment.

FIGS. 19A and 19B are diagrams for describing a specific example of the response information according to the second embodiment.

### DESCRIPTION OF EMBODIMENTS

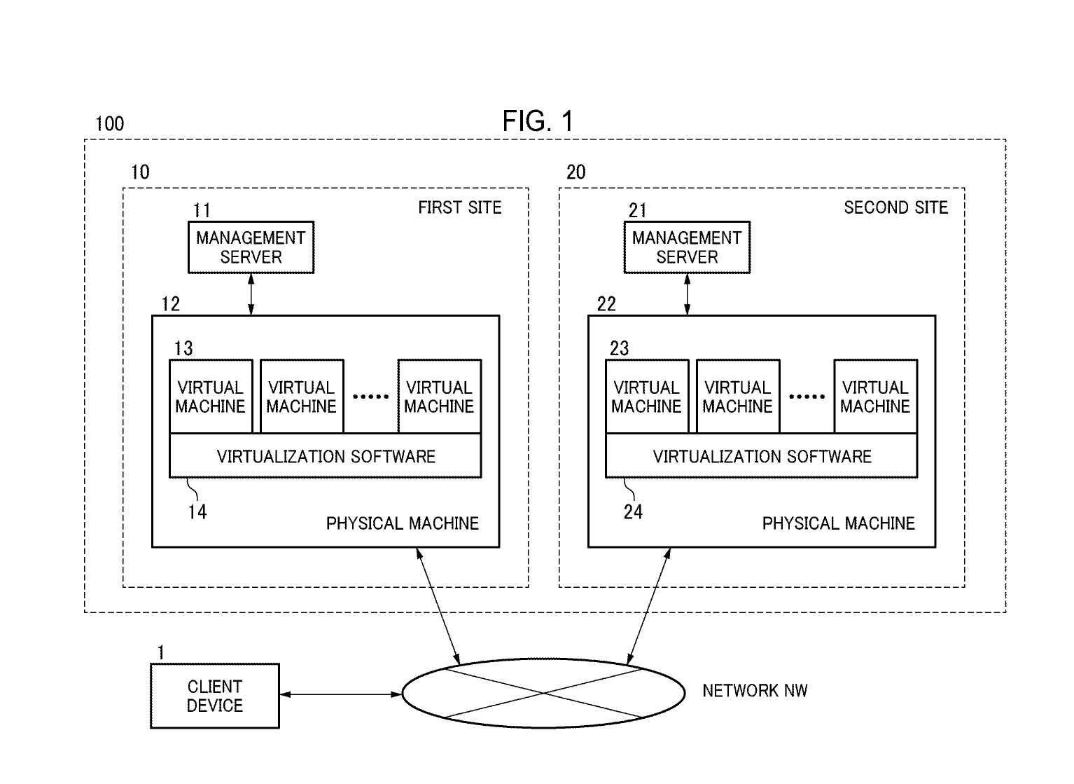

FIG. 1 is a diagram illustrating an entire configuration of an information processing system 100. The information processing system 100 illustrated in FIG. 1 is made up of physical machines provided in a first site 10 and a second site 20. The first and second sites 10 and 20 are located approximately several tens of km to several hundreds of km from each other, for instance.

A management server 11 and a physical machine 12 (a management target server 12 to be managed by the management server 11) that can communicate with the management server 11 and creates a virtual machine (VM) are provided in the first site 10, for instance. Moreover, a management server 21 and a physical machine 22 (a management target server 22 to be managed by the management server 21) that can communicate with the management server 21 and creates a virtual machine are provided in the second site 20, for instance. Devices in the first site 10 and devices in the second site 20 can access each other via a network NW. The network NW is a wide area network (WAN) or a local area network (LAN), for instance.

Moreover, in the example illustrated in FIG. 1, the physical machines 12 and 22 can access client device 1 provided outside the first and second sites 10 and 20.

A client device 1 (hereinafter also referred to as a first information processing device 1) is a terminal used by a user who uses a service provided by a service provider, for instance. The user transmits data (hereinafter also referred to as process communication) for requesting the physical machines 12 and 22 to execute processes, for instance, by using the client device 1. A plurality of client devices 1 may be present.

The management servers 11 and 21 issue instructions to the physical machines 12 and 22 to create virtual machines and manage created virtual machines.

Virtualization software 14 and 24 each is infrastructure software that creates virtual machines by allocating resources such as a CPU, a memory, a hard disk drive, a network, and the like of the physical machines 12 and 22 according to instructions from the management servers 11 and 21.

The physical machines 12 and 22 are physical machines having resources for allocation to virtual machines 13 and 23. Specifically, each physical machine includes a central processing unit (CPU), a random access memory (RAM), a large-capacity memory such as a hard disk drive (HDD), and a network. Each of the physical machines 12 and 22 may be formed of a plurality of physical machines.

The virtual machine 13 (hereinafter also referred to as a first virtual machine 13) is created by being allocated with the resources of the physical machine 12, and the operation system is constructed in the virtual machine 13, for instance. Moreover, the virtual machine 23 (hereinafter also referred to as a second virtual machine 23 or a second information processing device 23) is created by being allocated with the resources of the physical machine 12, and the standby system is constructed in the virtual machine 23, for instance.

In a normal operation mode, for instance, upon receiving process communication from the client device 1, the virtual machine 13 (the operation system) executes a process corresponding to the process communication and transmits an execution result to the client device 1. On the other hand, the virtual machine 23 (the standby system) performs standby without executing the process performed by the virtual machine 13 in the normal operation mode, for instance. When an abnormality occurs in the virtual machine 13, the virtual machine 23 succeeds and executes the process executed by the virtual machine 13 instead of the virtual machine 13 and transmits an execution result to the client device 1. In this way, for instance, even when it has become difficult to continue the processing in the operation system due to the occurrence of a natural disaster, the service provider can continue providing the service to users. Hereinafter, it is assumed that, when an operation system is constructed in the virtual machine 13, a standby system is also constructed in the virtual machine 23.

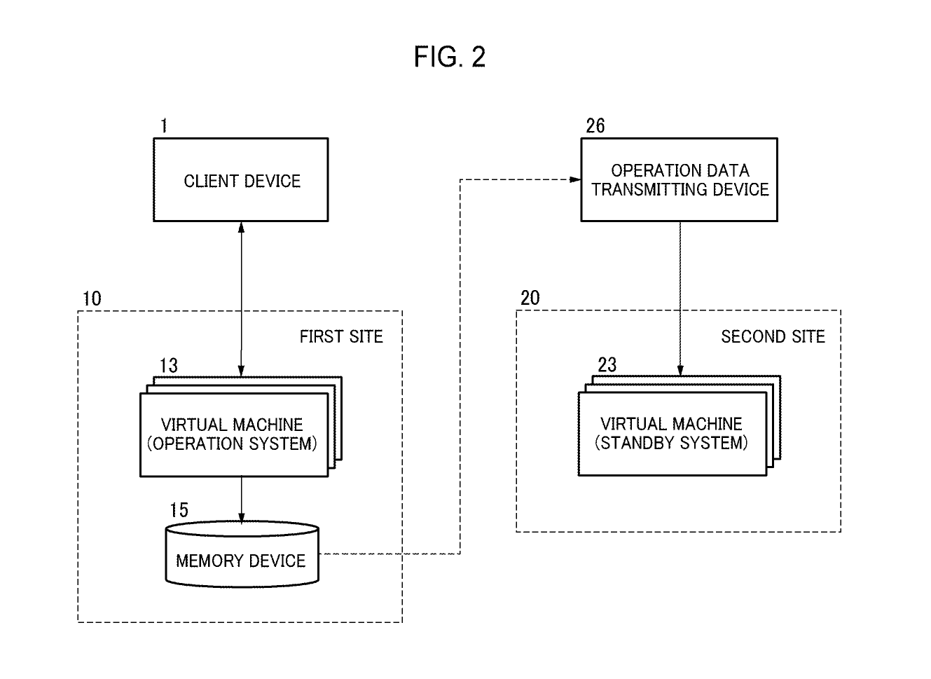

The standby system may be constructed only in the event of an abnormality in the operation system. In this case, the second site 20 receives and stores information needed to construct the standby system every predetermined period (for instance, every hour) from the first site 10 (the virtual machine 13). That is, the second site 20 mirrors (synchronizes) information needed to construct a standby system, held in the second site 20 with the information held in the first site 10. When an abnormality occurs in an operation system, the management server 21 extracts needed information from the stored information to construct a standby system. In this way, since the service provider does not need to construct a standby system in a normal operation mode, the resources for constructing the standby system can be used for other use such as application development until the standby system is constructed. Moreover, the service provider can construct a standby system without acquiring the information needed to construct the standby system from the virtual machine 13 when an abnormality occurs in the operation system.

[Testing of Standby System] Next, testing of a standby system will be described. FIG. 2 is a diagram for describing testing of a standby system according to a comparative example.

In the example illustrated in FIG. 2, the operation system is constructed in the virtual machine 13 of the first site 10. Moreover, the standby system is constructed in the virtual machine 23 of the second site 20.

Here, the standby system may perform a process different from the process executed by the operation system such as development of applications or testing of operations in a normal operation mode. Moreover, the standby system may function as a standby system of a plurality of operation systems. Thus, even when the same resources as the operation system are allocated to the standby system, the standby system may be unable to provide the same processing performance as the processing performance of the operation system depending on the situation of a natural disaster occurred.

Thus, the service provider performs an evaluation test in advance to know whether the standby system can execute the process of an operation system in various situations. In this way, the service provider can prevent the occurrence of a situation in which the standby system cannot succeed the process of the operation system in the event of a natural disaster or the like.

Here, the service provider performs the test without connecting the virtual machine 23 in which the standby system is constructed to the client device 1 or the virtual machine 13 in which the operation system is constructed as illustrated in FIG. 2 from the need to prevent the test data in the standby system from flowing into the operation system.

Specifically, as illustrated in FIG. 2, the virtual machine 13 stores the operation data received from the client device 1 in a memory device 15. An operation data transmitting device 26 transmits the operation data stored in the memory device 15 to the virtual machine 23 during testing of the virtual machine 23. In this way, the standby system can execute processes based on the operation data.

However, in this case, the standby system cannot perform processing at the same time as the time at which the operation system performs processing on the operation data. Thus, the service provider cannot perform testing on resources including the network or the like between the client device 1 and the virtual machine 23. Therefore, in this case, the service provider cannot perform highly reliable testing on the standby system.

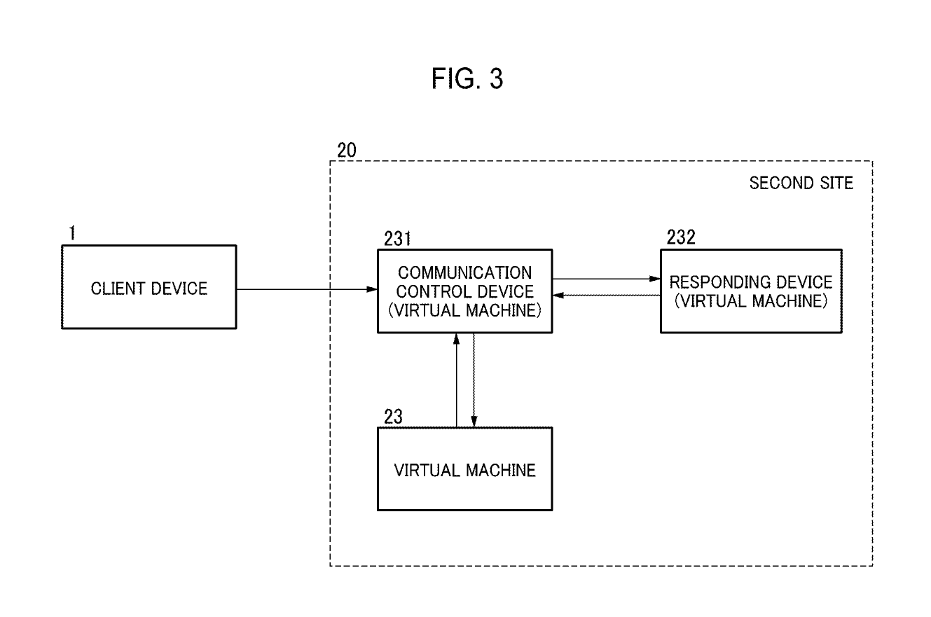

Thus, in the present embodiment, as illustrated in FIG. 3, a communication control device 231 and a responding device 232 are provided. The communication control device 231 and the responding device 232 are virtual machines created in the physical machine 22 of the second site 20, for instance. The communication control device 231 and the responding device 232 performs a process (hereinafter also referred to as a communication control process) of controlling communication between the client device 1 and the virtual machine 23.

FIG. 3 is a diagram for describing the communication control process according to the first embodiment and the configuration of the responding device and the standby system. In the example illustrated in FIG. 3, the communication control device 231 transmits process communication to the virtual machine 23 when the communication control device 231 receives the process communication (hereinafter also referred to as first process communication) from the client device 1 to the virtual machine 23. Moreover, the communication control device 231 does not transmit process communication to the client device 1 when the communication control device 231 receives the process communication (hereinafter also referred to as second process communication) from the virtual machine 23 to the client device 1.

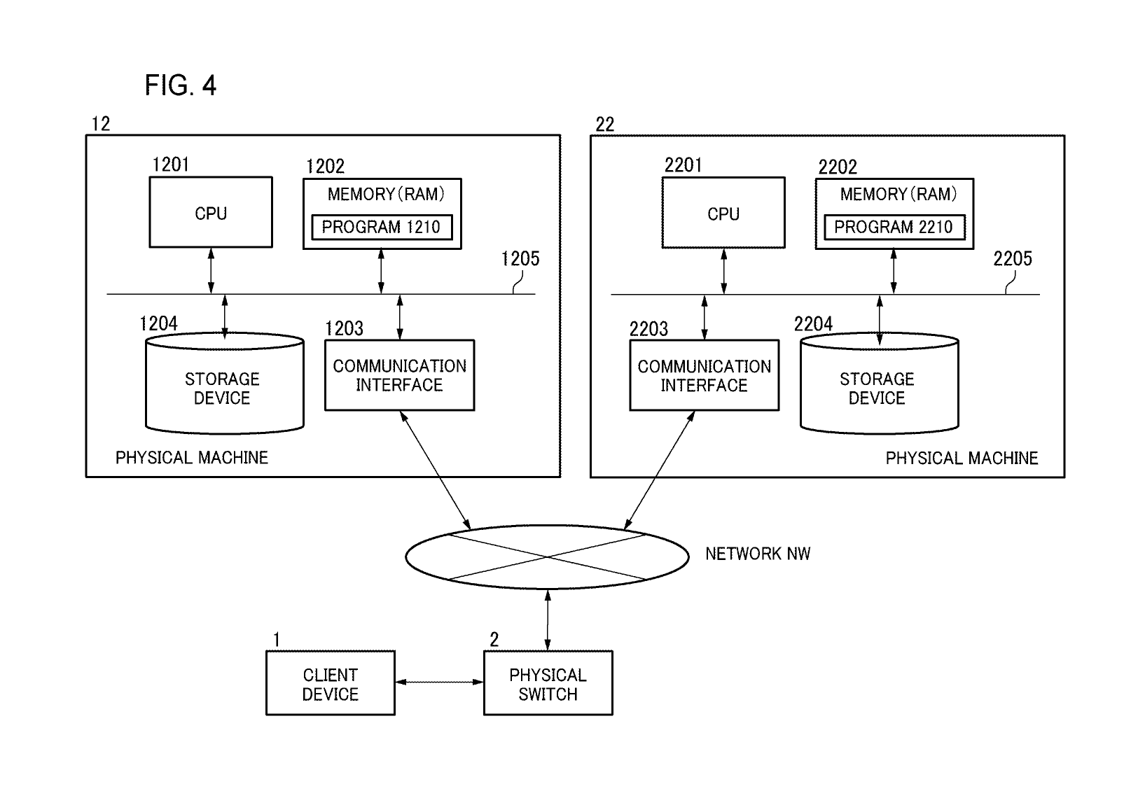

By doing so, the service provider can allow transmission of first process communication from the client device 1 to the virtual machine 23 while preventing transmission of second process communication from the virtual machine 23 to the client device 1. Thus, the virtual machine 23 can execute a process corresponding to the first process communication transmitted by the client device 1.

[Hardware Configuration of Information Processing System] Next, a hardware configuration of the information processing system 100 will be described. FIG. 4 is a diagram illustrating a hardware configuration of the information processing system 100.

The information processing system 100 illustrated in FIG. 4 includes a physical switch device 2 (hereinafter also referred to as a physical switch 2) disposed between the client device 1 and the network NW in addition to the physical machine 12 and the physical machine 22 described in FIG. 1.

The physical switch 2 receives the first process communication transmitted from the client device 1 to the virtual machine 13. Moreover, the physical switch 2 controls the received first process communication and transmits the same to the virtual machine 13 while transmitting the same to the virtual machine 23 via the communication control device 231. Specifically, the physical switch 2 specifies a destination of the first process communication based on information on a destination IP address included in the first process communication. When the destination IP address included in the first process communication designates the virtual machine 13, the physical switch 2 transmits the first process communication to the virtual machine 13 and transmits the first process communication to the virtual machine 23. By doing so, the physical switch 2 can transmit the first process communication transmitted from the client device 1 to the virtual machine 13 to the virtual machine 23 at the same time as the virtual machine 13.

The physical machine 12 includes a CPU 1201 which is a processor and a memory 1202 such as a RAM. Moreover, the physical machine 12 includes a communication interface 1203 (a network card in the physical machine 12) for accessing the client device 1 and the physical machine 22 via the network NW and a storage device 1204 having a memory area. These units are connected to each other via a bus 1205.

The storage device 1204 stores a program 1210 for performing a process for the first process communication in a program storage area (not illustrated) in the storage device 1204, for instance. The storage device 1204 is a large-capacity memory device such as a HDD or a solid state drive (SSD), for instance. The storage device 1204 may correspond to the memory device 15 described in FIG. 2, for instance.

As illustrated in FIG. 4, the CPU 1201 loads the program 1210 from the storage device 1204 to the memory 1202 during execution of the program 1210 and performs the process for the first process communication in cooperation with the program 1210.

Moreover, the physical machine 22 includes a CPU 2201 which is a processor and a memory 2202 such as a RAM. Moreover, the physical machine 22 includes a communication interface 2203 (a network card in the physical machine 22) for accessing the client device 1 and the physical machine 12 via the network NW and a storage device 2204 having a memory area. These respective units are connected to each other via a bus 2205.

The storage device 2204 stores a program 2210 for performing the communication control process and the process for the first process communication in a program storage area (not illustrated) in the storage device 2204, for instance. The storage device 2204 is a large-capacity memory device such as a HDD or a SSD, for instance.

As illustrated in FIG. 4, the CPU 2201 loads the program 2210 from the storage device 2204 to the memory 2202 during execution of the program 2210 and performs the communication control process and the process for the first process communication in cooperation with the program 2210.

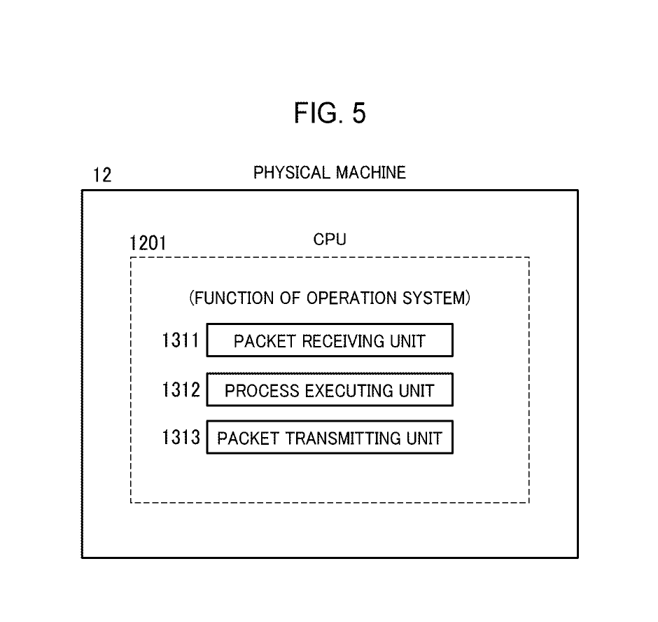

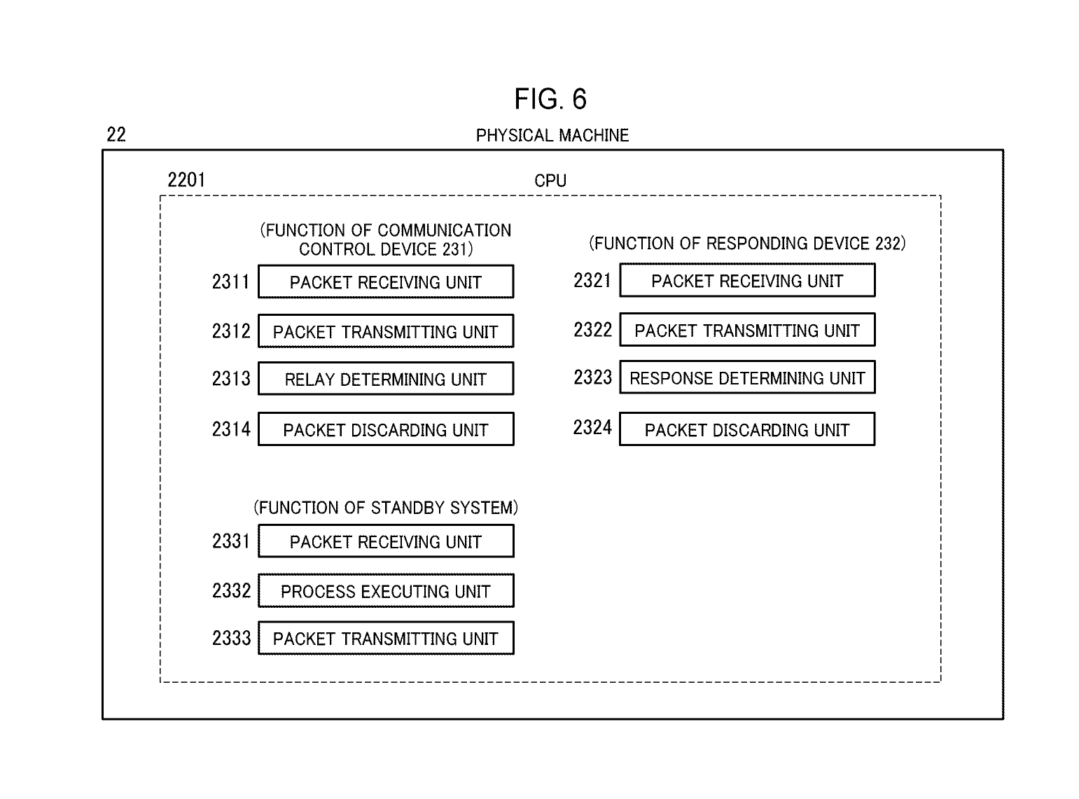

The physical switch device 2 may include a CPU, a memory, a communication interface, and a storage device similarly to the physical machine 12 and the physical machine 22. Moreover, although it is assumed that a physical L3 switch or the like is used as the physical switch device 2, a virtual L3 switch or the like may be used as the physical switch device 2, for instance.

[Function of Information Processing System] FIG. 5 is a functional block diagram of the first site 10. FIG. 6 is a functional block diagram of the second site 20 illustrated in FIG. 4. In the following description, it is assumed that a virtual machine (hereinafter also referred to as a virtual machine 231) that functions as the communication control device 231 described in FIG. 3 is also created in the physical machine 22 in addition to the virtual machine 23 described in FIG. 1 and the like. Moreover, it is also assumed that a virtual machine (hereinafter also referred to as a virtual machine 232) that functions as the responding device 232 described in FIG. 3 is also created in the physical machine 22.

The CPU 1201 of the physical machine 12 cooperates with the program 1210 to operate as a packet receiving unit 1311, a process executing unit 1312, and a packet transmitting unit 1313 which are the functions of the operation system as illustrated in FIG. 5.

Moreover, the CPU 2201 of the physical machine 22 cooperates with the program 2210 to operate as a packet receiving unit 2311, a packet transmitting unit 2312, a relay determining unit 2313, and a packet discarding unit 2314 which are the functions of the communication control device 231 as illustrated in FIG. 6. Further, the CPU 2201 of the physical machine 22 cooperates with the program 2210 to operate as a packet receiving unit 2321, a packet transmitting unit 2322, a response determining unit 2323, and a packet discarding unit 2324 which are the functions of the responding device 232. Moreover, the CPU 2201 of the physical machine 22 cooperates with the program 2210 to operate as a packet receiving unit 2331, a process executing unit 2332, and a packet transmitting unit 2333 which are the functions of the standby system.

[Function of Operation System (Virtual Machine 13)] First, the function of the operation system will be described.

The packet receiving unit 1311 of the operation system receives the first process communication transmitted from the client device 1 to the virtual machine 13, for instance.

The process executing unit 1312 of the operation system executes the process corresponding to the first process communication received by the packet receiving unit 1311, for instance. Examples of the process corresponding to the first process communication include referring and updating of the information stored in the memory device 15 described in FIG. 2.

The packet transmitting unit 1311 of the operation system transmits the result of the process executed by the process executing unit 1312 to the client device 1, for instance.

[Function of Communication control device 231] Next, the function of the communication control device 231 will be described. For instance, the communication control device 231 is a virtual machine that functions as a virtual firewall.

The packet receiving unit 2311 of the communication control device 231 receives the first process communication transmitted by the physical switch device 2, for instance.

When the packet receiving unit 2311 receives the first process communication, for instance, the packet transmitting unit 2312 of the communication control device 231 transmits the received first process communication to the virtual machine 23.

Upon receiving the second process communication from the virtual machine 23, for instance, the relay determining unit 2313 of the communication control device 231 determines whether transmission of the received second process communication to the responding device 232 without transmitting the received second process communication to the client device 1 is needed. The relay determining unit 2313 determines whether or not to transmit the second process communication to the responding device 232 by referring to transmission information, for instance. The transmission information is information for specifying the second process communication that the communication control device 231 transmits to the responding device 232. The details of the transmission information will be described later.

The packet discarding unit 2314 of the communication control device 231 discards the second process communication when the relay determining unit 2313 has determined that transmission of the second process communication to the responding device, for instance, is not needed. On the other hand, the packet transmitting unit 2312 transmits the second process communication to the responding device 232 when the relay determining unit 2313 has determined that transmission of the second process communication to the responding device 232 is needed.

That is, the communication control device 231 transmits the first process communication to the virtual machine 23 upon receiving the first process communication from the client device 1 whereas the communication control device 231 transmits the second process communication to the responding device 232 without transmitting the same to the client device 1 upon receiving the second process communication from the virtual machine 23.

[Function of Responding Device 232] Next, the function of the responding device 232 will be described.

The packet receiving unit 2321 of the responding device 232 receives the second process communication transmitted by the communication control device 231, for instance.

The packet transmitting unit 2322 of the responding device 232 receives a response specified by the response determining unit 2323 described later to the virtual machine 23, for instance.

The response determining unit 2323 of the responding device 232 refers to response information when the packet receiving unit 2321 receives the second process communication, for instance. The response information is information that correlates the second process communication with the content of the response thereof. Moreover, the response determining unit 2323 refers to the response information to specify a response to the second process communication received by the packet receiving unit 2321. A specific example of the response information will be described later.

The packet discarding unit 2324 of the responding device 232 discards the second process communication when the response determining unit 2323 has determined that transmission of a response to the second process communication to the virtual machine 23, for instance, is not needed.

[Function of Standby System (Virtual Machine 23)] The packet receiving unit 2311 of the standby system receives the first process communication transmitted from the communication control device 231 (the client device 1) to the virtual machine 23, for instance.

The process executing unit 2312 of the standby system executes the process corresponding to the first process communication received by the packet receiving unit 2311 similarly to the process executing unit 1312 of the operation system, for instance.

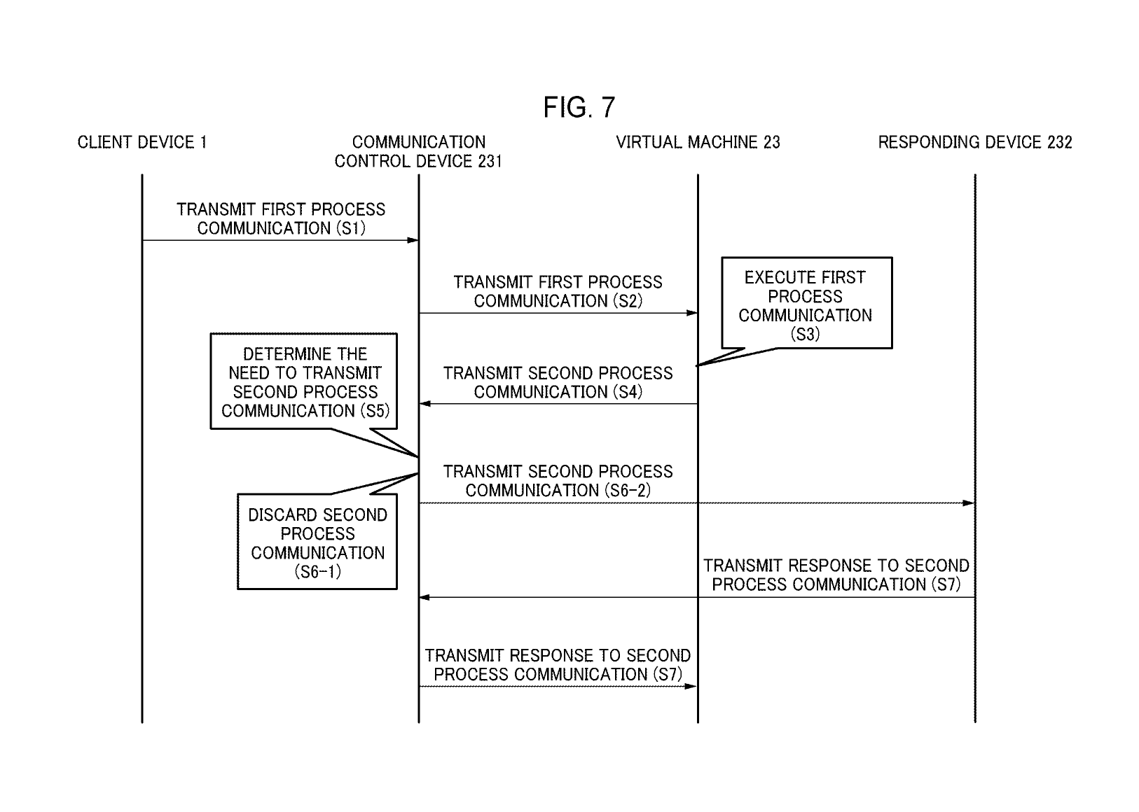

The packet transmitting unit 2311 of the standby system transmits the result of the process executed by the process executing unit 2312 to the communication control device 231 (the client device 1), for instance.

[Outline of First Embodiment] Next, a first embodiment will be described. FIG. 7 is a sequence chart illustrating an outline of the communication control process according to the first embodiment.

As illustrated in FIG. 7, first, the communication control device 231 receives the first process communication from the client device 1, for instance (S1). Moreover, the communication control device 231 transmits the received first process communication to the virtual machine 23, for instance (S2).

That is, when the communication control device 231 receives the first process communication from the client device 1, the communication control device 231 transmits the first process communication to the virtual machine 23 without discarding the first process communication. By doing so, the virtual machine 23 can receive the first process communication transmitted by the client device 1. Thus, the virtual machine 23 can execute the process for the first process communication transmitted by the client device 1. Therefore, the service provider can perform highly reliable testing on the standby system.

Subsequently, the virtual machine 23 executes the process corresponding to the first process communication, for instance (S3). Moreover, the virtual machine 23 transmits a response (second process communication) to the first process communication to the client device 1, for instance (S4). In contrast, the communication control device 231 receives the second process communication transmitted by the virtual machine 23, for instance. Moreover, the communication control device 231 determines whether or not to transmit the received second process communication to the responding device 232 without transmitted the same to the client device 1, for instance (S5).

That is, the communication control device 231 transmits the first process communication to the virtual machine 23 upon receiving the first process communication directed from the client device 1 to the virtual machine 23 whereas the communication control device 231 does not transmit the second process communication to the client device 1 upon receiving the second process communication directed from the virtual machine 23 to the client device 1. In this way, the service provider can prevent the test data transmitted from the virtual machine 23 from having an adverse effect on the service provided to the users.

The communication control device 231 discards the second process communication when it is determined that transmission of the received second process communication to the responding device 232, for instance, is not needed (S6-1). On the other hand, the communication control device 231 transmits the second process communication to the responding device 232 when it is determined that transmission of the received second process communication to the responding device 232, for instance, is needed (S6-2).

That is, the communication control device 231 transmits the received second process communication to the responding device 232 when transmission of a response to the received second process communication to the virtual machine 23 is needed. On the other hand, the communication control device 231 discards the received second process communication without transmitting the same to the responding device 232 when it is determined that transmission of a response to the received second process communication to the virtual machine 23 is not needed. The details of the process S5 by the communication control device 231 will be described later.

Subsequently, the responding device 232 transmits a response to the received second process communication to the communication control device 231 upon receiving the second process communication from the communication control device 231, for instance. Moreover, the communication control device 231 transmits a response to the received second process communication to the virtual machine 23 upon receiving the response to the second process communication from the responding device 232, for instance (S7).

In this manner, according to the first embodiment, upon receiving first process communication directed from the client device 1 to the virtual machine 23, the communication control device 231 transmits the received first process communication to the virtual machine 23. Upon receiving second process communication from the virtual machine 23, the communication control device 231 transmits the received second process communication to the responding device 232 when transmission of the same to the responding device 232 without transmitting the received second process communication to the client device 1 is needed. After that, upon receiving second process communication from the communication control device 231, the responding device 232 transmits a response to the received second process communication to the virtual machine 23. Further, upon receiving the response to the second process communication from the responding device 232, for instance, the communication control device 231 transmits the received response to the second process communication to the virtual machine 23.

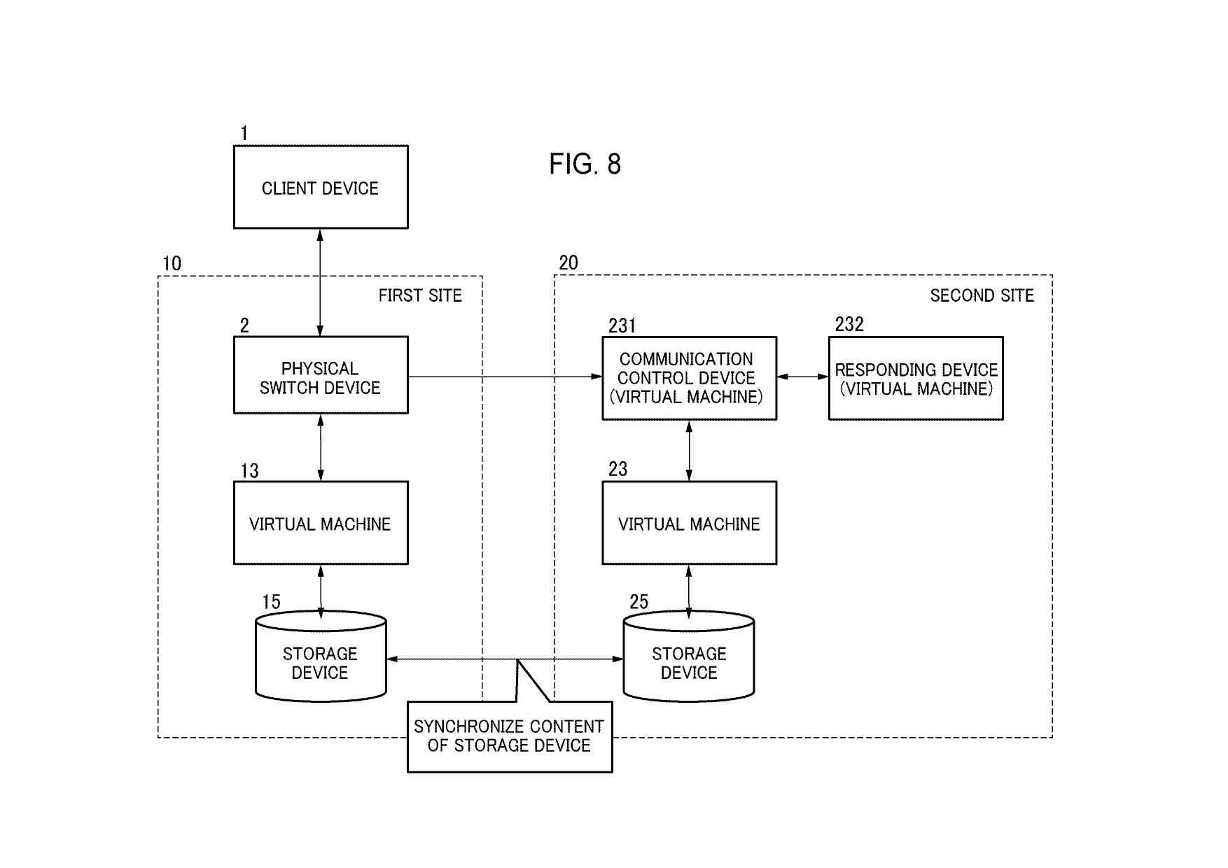

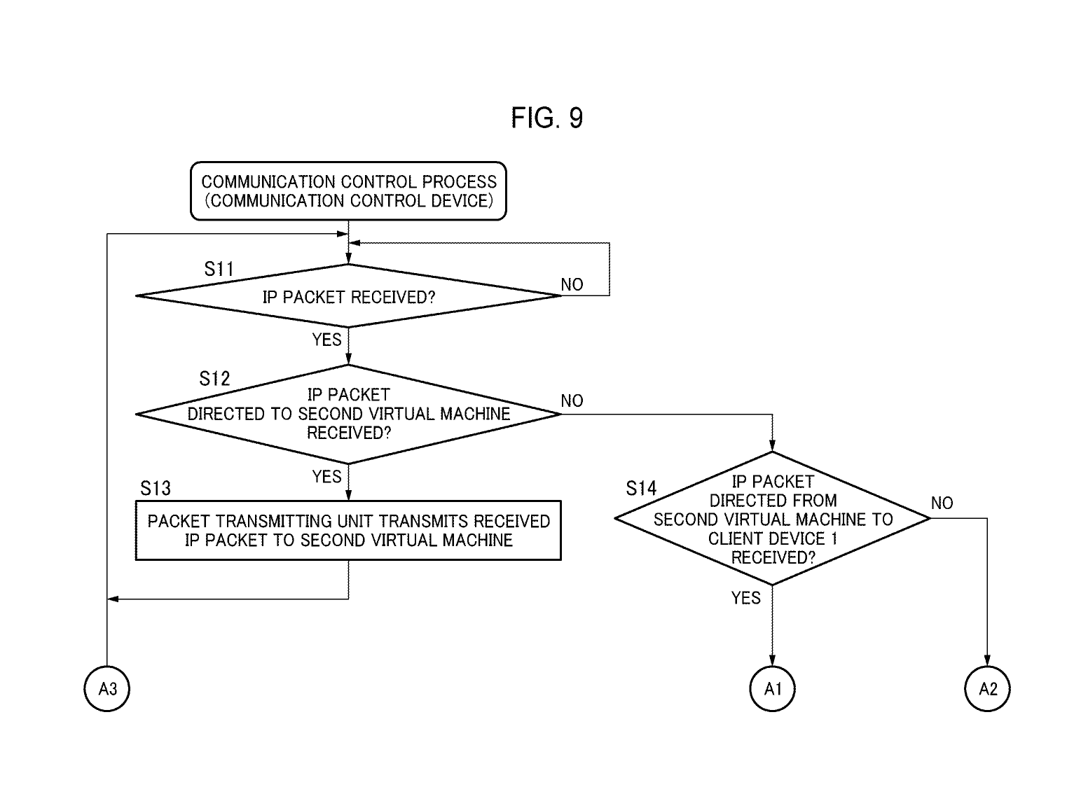

In this way, the communication control device 231 can allow transmission of the first process communication from the client device 1 to the virtual machine 23 while preventing the second process communication from being transmitted from the virtual machine 23 to the client device 1. Moreover, the communication control device 231 can allow the virtual machine 23 to receive a response needed to test the virtual machine 23. Thus, the communication control device 231 can measure the throughput or the like in a state in which the virtual machine 23 executes processing under the same condition as the virtual machine 13.

[Details of First Embodiment] Next, the details of the first embodiment will be described. FIGS. 9 to 11 are flowcharts illustrating the details of the communication control process according to the first embodiment. Moreover, FIGS. 8 and 12 to 15 are diagrams for describing the details of the communication control process according to the first embodiment. The details of the communication control process illustrated in FIGS. 9 to 11 will be described with reference to FIGS. 8 and 12 to 15.
[Configuration of First Embodiment] FIG. 8 is a diagram for describing the details of the first embodiment.

In the example illustrated in FIG. 8, information stored by the virtual machine 13 (the operation system) and information needed to construct the operation system, for instance, are stored in the memory device 15. Moreover, the memory device 25 accesses the memory device 15 at a predetermined time regardless of whether an abnormality has occurred in the operation system to mirror (synchronize) the content of the information stored in the memory device 25 with the content of the information stored in the memory device 15. The predetermined time is the time at which the content stored in the memory device 15 is updated by the client device 1.

In this way, the memory device 25 can store the information for executing the process corresponding to the first process communication in the memory device 25 to be used when the virtual machine 23 executes the process. Thus, the virtual machine 23 can perform the same process as the virtual machine 13 (the operation system).

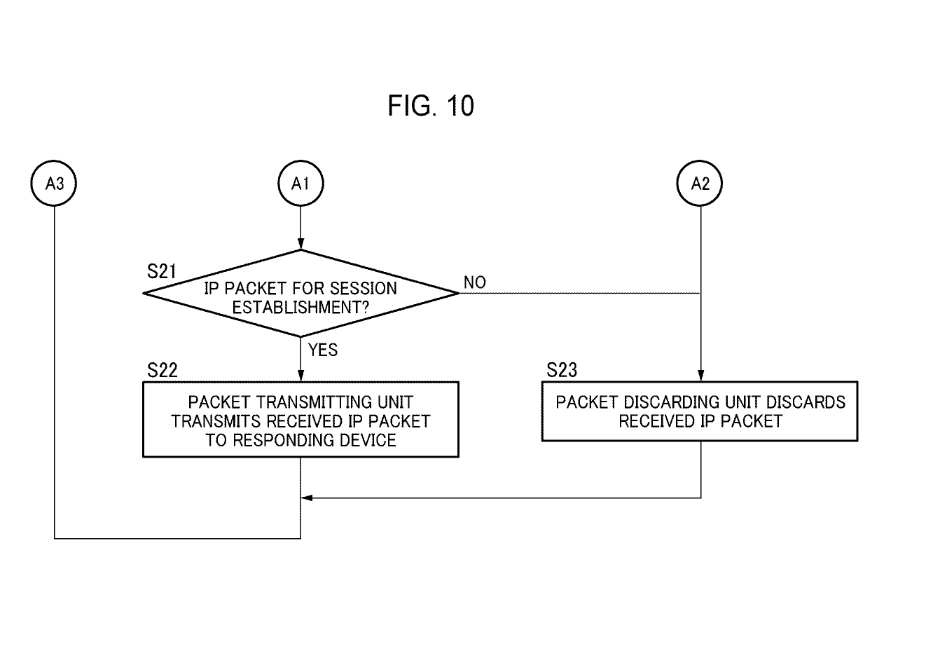

The memory device 15 may correspond to the storage device 1204 described in FIG. 4, for instance, and the memory device 25 may correspond to the storage device 2204 described in FIG. 4, for instance. Hereinafter, the communication control process of the communication control device 231 and the responding device 232 will be described.

[Process of Communication Control Device 231] First, the communication control process of the communication control device 231 will be described. FIGS. 9 and 10 are flowcharts illustrating the details of the communication control process of the communication control device 231. In the following description, it is assumed that the first and second process communication are Internet protocol (IP) packets transmitted and received to issue a request to establish a session in a 3-way handshake.

Specifically, when the client device 1 establishes a session with the virtual machine 23 according to a 3-way handshake, the client device 1 first transmits a SYN (synchronization) packet which is a connection request for the virtual machine 23 to the virtual machine 23. Upon receiving the SYN packet, the virtual machine 23 transmits a SYN/ACK (acknowledgement) packet which is an acknowledgement thereof to the client device 1. Further, upon receiving the SYN/ACK packet, the client device 1 transmits an ACK packet to the virtual machine 23. In this way, a session is established between the client device 1 and the virtual machine 23. That is, in this case, the SYN packet corresponds to the first process communication and the SYN/ACK packet corresponds to the second process communication.

As illustrated in FIG. 9, the packet receiving unit 2311 of the communication control device 231 performs standby until the packet receiving unit 2311 receives an IP packet from a device or the like that can access the communication control device 231, for instance (S11: NO). Specifically, the packet receiving unit 2311 performs standby until the packet receiving unit 2311 receives an IP packet from the client device 1, for instance.

When the IP packet is received (S11: YES), the packet receiving unit 2311 determines whether the received IP packet is an IP packet transmitted to the virtual machine 23, for instance (S12). Specifically, the packet receiving unit 2311 refers to a destination IP address included in an IP header of the received IP packet, for instance. Moreover, the packet receiving unit 2311 determines whether the received IP packet is an IP packet transmitted to the virtual machine 23, for instance. A specific example of referring to the destination IP address will be described later.

When the received IP packet is the IP packet transmitted to the virtual machine 23 (S12: YES), the packet transmitting unit 2312 transmits the received IP packet to the virtual machine 23, for instance (S13). In this way, the virtual machine 23 can receive the IP packet transmitted from the client device 1, for instance. Thus, the virtual machine 23 can performs a process based on the IP packet transmitted from the client device 1.

Moreover, when the received IP packet is not the IP packet transmitted to the virtual machine 23 (S12: NO), the relay determining unit 2313 determines whether the received IP packet is the IP packet transmitted from the virtual machine 23 to the client device 1, for instance (S14).

When the received IP packet is the IP packet transmitted from the virtual machine 23 to the client device 1 (S14: YES), the relay determining unit 2313 determines whether the received IP packet is an IP packet used for establishing a session, for instance (S21). Specifically, the relay determining unit 2313 determines whether the IP packet received in S21 is a SYN/ACK packet. When the received IP packet is a SYN/ACK packet (S21: YES), the packet transmitting unit 2312 transmits the received IP packet to the responding device 232 without transmitting the same to the client device 1, for instance (S22). A specific example of the process of the relay determining unit 2313 will be described later.

On the other hand, when the received IP packet is not the IP packet transmitted from the virtual machine 23 to the client device 1 (S14: NO), the packet discarding unit 2314 discards the IP packet received by the packet receiving unit 2311, for instance (S23). Moreover, similarly, when the received IP packet is not the SYN/ACK packet (S21: NO), the packet discarding unit 2314 discards the IP packet received by the packet receiving unit 2311, for instance (S23).

That is, the communication control device 231 transmits all IP packets transmitted to the virtual machine 23 to the virtual machine 23. In this way, the virtual machine 23 can perform processes based on the IP packet transmitted from the client device 1. On the other hand, upon receiving the IP packet transmitted from the virtual machine 23, the communication control device 231 discards the IP packet in principle. In this way, it is possible to prevent the IP packet transmitted from the virtual machine 23 from having an adverse effect on the client device 1 or the like.

Here, for the virtual machine 23 to receive an IP packet transmitted from the client device 1, establishment of a session between the virtual machine 23 and the client device 1 is needed. Specifically, the virtual machine 23 needs to transmit a SYN/ACK packet corresponding to the SYN packet received from the client device 1 to the client device 1 in order to establish a session with the client device 1. Further, the virtual machine 23 needs to receive an ACK packet which is a response to the transmitted SYN/ACK packet from the client device 1 in order to establish a session with the client device 1. In this way, upon receiving the ACK packet from the client device 1, the virtual machine 23 can determine that a session with the client device 1 has been established, and after that, can receive the IP packet transmitted from the client device 1

However, the communication control device 231 of the present embodiment does not transmit the IP packet transmitted by the virtual machine 23 to the client device 1 in order to prevent an adverse effect on the client device 1 or the like. That is, the communication control device 231 does not transmit the SYN/ACK packet received from the virtual machine 23 to the client device 1. Thus, the virtual machine 23 cannot receive the ACK packet from the client device 1.

Thus, the communication control device 231 of the present embodiment transmits a SYN/ACK packet to the responding device 232 without discarding the same only when the communication control device 231 has received the SYN/ACK packet directed from the virtual machine 23 to the client device 1. Moreover, the responding device 232 transmits an ACK packet which is a response to the SYN/ACK packet to the virtual machine 23 instead of the client device 1, which will be described later. As a result, the responding device 232 can allow the virtual machine 23 to determine that a session with the client device 1 has been established. Thus, the virtual machine 23 can receive an IP packet transmitted from the client device 1 after that and can execute a process based on the received IP packet.

[Specific Example of Process of Relay Determining Unit 2313] Next, a specific example of the process (S14, S21) of the relay determining unit 2313 will be described. The relay determining unit 2313 extracts information included in an IP header and a TCP (transmission control protocol) header of the received IP packet, for instance, to determine whether the extracted information is included in transmission information.

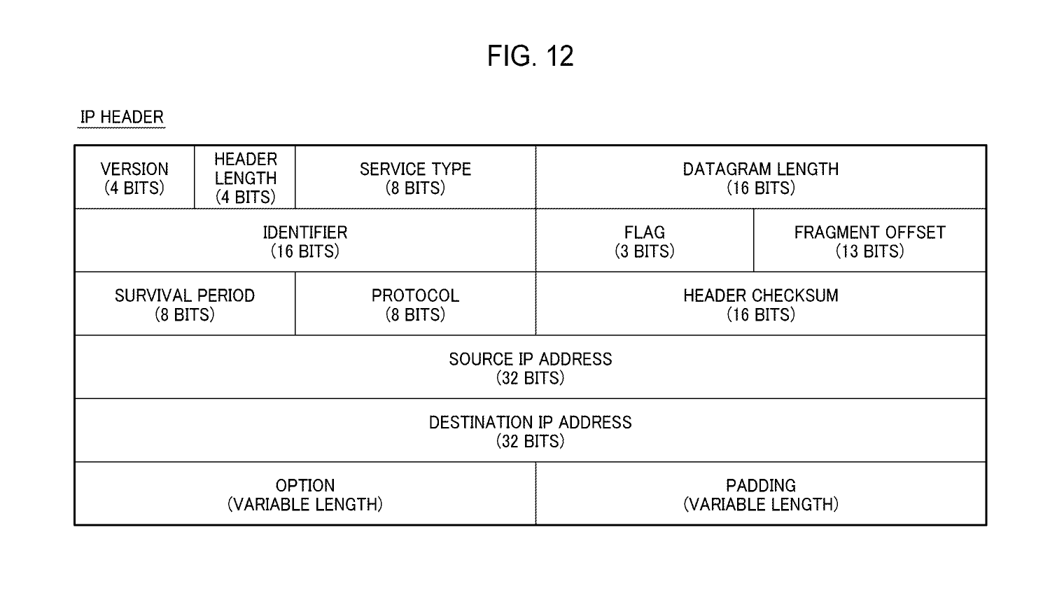

First, a specific example of the information extracted from the IP header and the TCP header will be described. FIG. 12 is a diagram for describing the layout of an IP header. As illustrated in FIG. 12, the IP header includes, from the start, a version (4 bits), a header length (4 bits), a service type (8 bits), a datagram length (16 bits), an identifier (16 bits), a flag (3 bits), and a fragment offset (13 bits). Continuously, the IP header includes a survival period (8 bits), a protocol (8 bits), a header checksum (16 bits), a source IP address (32 bits), a destination IP address (32 bits), an option (variable length), and a padding (variable length).

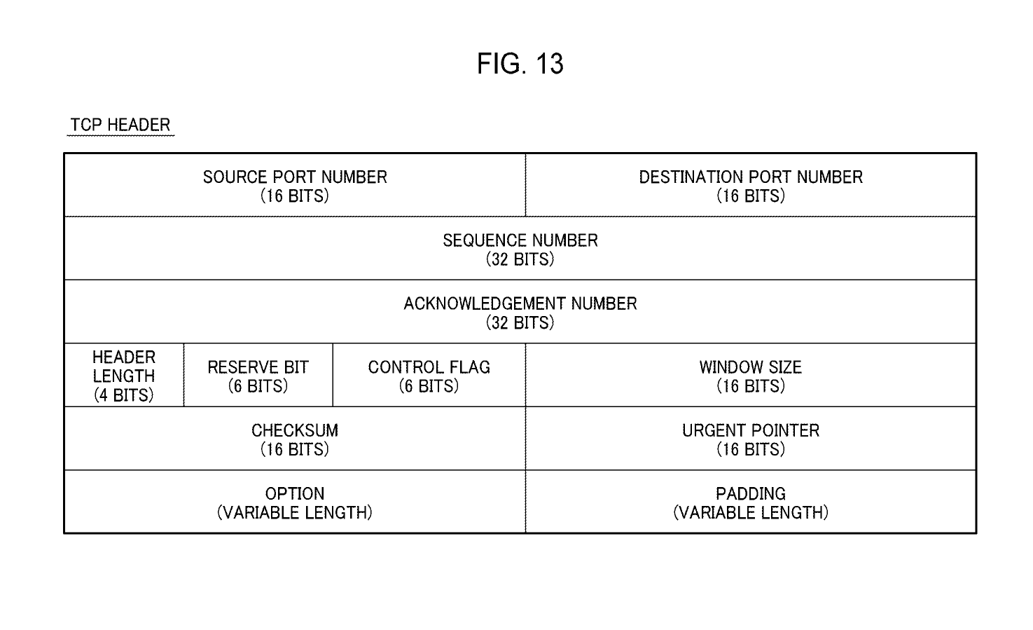

FIG. 13 is a diagram for describing the layout of a TCP header. As illustrated in FIG. 13, the TCP header includes, from the start, a source port number (16 bits), a destination port number (16 bits), a sequence number (32 bits), and an acknowledgement number (32 bits). Continuously, the TCP header includes a header length (4 bits), a reserve bit (6 bits), a control flag (6 bits), a window size (16 bits), a checksum (16 bits), an urgent pointer (16 bits), an option (variable length), and a padding (variable length).

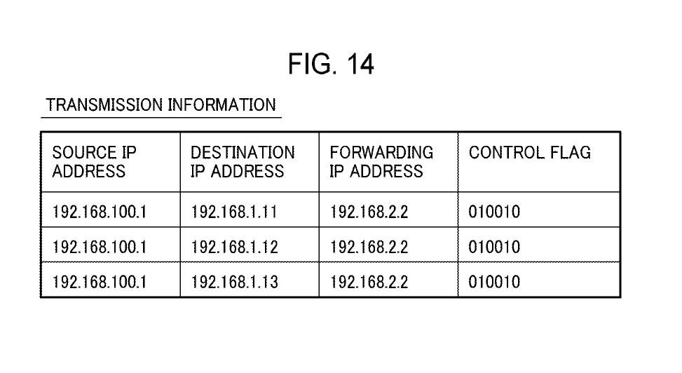

FIG. 14 is a diagram for describing a specific example of the transmission information in the first embodiment. The transmission information is information for identifying the IP packet (the second process communication) that the communication control device 231 transmits to the responding device 232.

The transmission information illustrated in FIG. 14 includes “source IP address”, “destination IP address”, “forwarding IP address”, and “control flag” for specifying the IP packet transmitted to the responding device 232.

The control flag is information included in the TCP header described in FIG. 13 and includes information for identifying the type (SYN packet or SYN/ACK packet, or the like) of the received IP packet. Specifically, the control flag includes, from the start, a URG (urgent) bit indicating that urgent data is included in the IP packet and an ACK bit indicating that an acknowledge number of the TCP header of the IP packet is valid. Continuously, the control flag includes a PSH (push) bit indicating that delivery of the IP packet to an application without buffering the IP packet is needed and a RST (reset) bit indicating that a session is to be ended forcibly. Further, the control flag includes a SYN bit indicating that the IP packet is an IP packet used for requesting establishment of a session and a FIN flag indicating that the IP packet is an IP packet for requesting a normal termination of a session.

That is, the control flag included in the TCP header of the SYN packet is in a state (“000010”) in which 1 is set to the SYN bit only. Moreover, the control flag included in the TCP header of the SYN/ACK packet is in a state (“010010”) in which 1 is set to the SYN bit and the ACK bit. Further, the control flag included in the TCP header of the ACK packet is in a state (“010010”) in which 1 is set to the ACK bit only.

In the transmission information illustrated in FIG. 14, “192.168.100.1” is set as the “source IP address”, “192.168.1.11” is set as the “destination IP address”, “192.168.2.2” is set as the “forwarding IP address”, and the “010010” is set as “control flag”. The description of the other information in FIG. 14 will not be provided.

That is, in S14 of FIG. 9, when the packet receiving unit 2311 receives an IP packet, the relay determining unit 2313 extracts the source IP address and the destination IP address included in the IP header of the received IP packet. Moreover, the relay determining unit 2313 checks whether a combination of the extracted source IP address and destination IP address is present in the transmission information. In this way, the relay determining unit 2313 can determine whether the received IP address has been transmitted from the virtual machine 23 to the client device 1. Moreover, the relay determining unit 2313 can transmit only the IP packet transmitted from the virtual machine 23 to the client device 1 to the responding device 232.

Moreover, in S21 of FIG. 10, when the packet receiving unit 2311 receives an IP packet, the relay determining unit 2313 extracts a control flag included in the TCP header of the received IP packet. The relay determining unit 2313 checks whether the extracted control flag is present in the transmission information. In this way, the relay determining unit 2313 can specify the SYN/ACK packet (the IP packet of which the control flag is “010010”) for establishing a session between the virtual machine 23 and the client device 1, for instance, and transmit the SYN/ACK packet to the responding device 232.

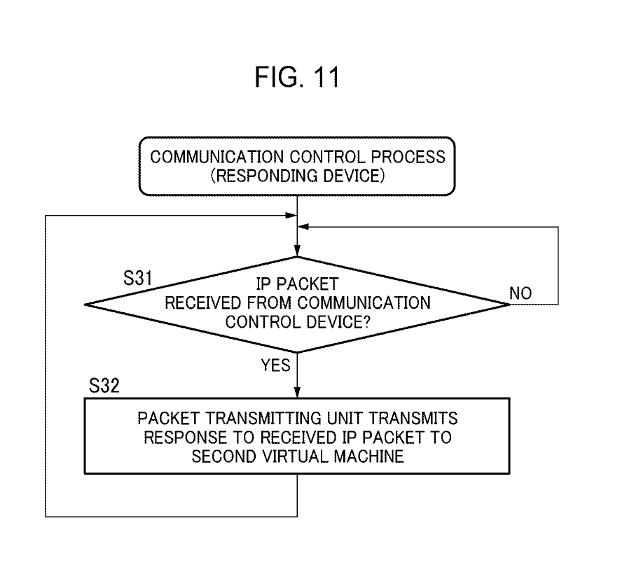

After that, the packet transmitting unit 2312 transmits (forwards) the specified SYN/ACK packet to an IP address set in the “forwarding IP address”.

[Process of Responding Device 232] Next, the communication control process of the responding device 232 will be described. FIG. 11 is a flowchart illustrating the details of the communication control process of the responding device 232.

First, the packet receiving unit 2321 of the responding device 232 performs standby until the packet receiving unit 2321 receives an IP packet from the communication control device 231, for instance (S31: NO). When the IP packet is received (S31: YES), the packet transmitting unit 2322 of the responding device 232 transmits a response to the received IP packet to the virtual machine 23 by referring to the response information, for instance (S32). That is, when the responding device 232 has received the IP packet from the communication control device 231, the IP packet is a SYN/ACK packet that the virtual machine 23 has transmitted to the client device 1 to request establishment of a session. Thus, upon receiving the IP packet from the communication control device 231, the packet transmitting unit 2322 transmits an ACK packet which is a response to the SYN/ACK packet to the virtual machine 23. A specific example of the response information will be described below.

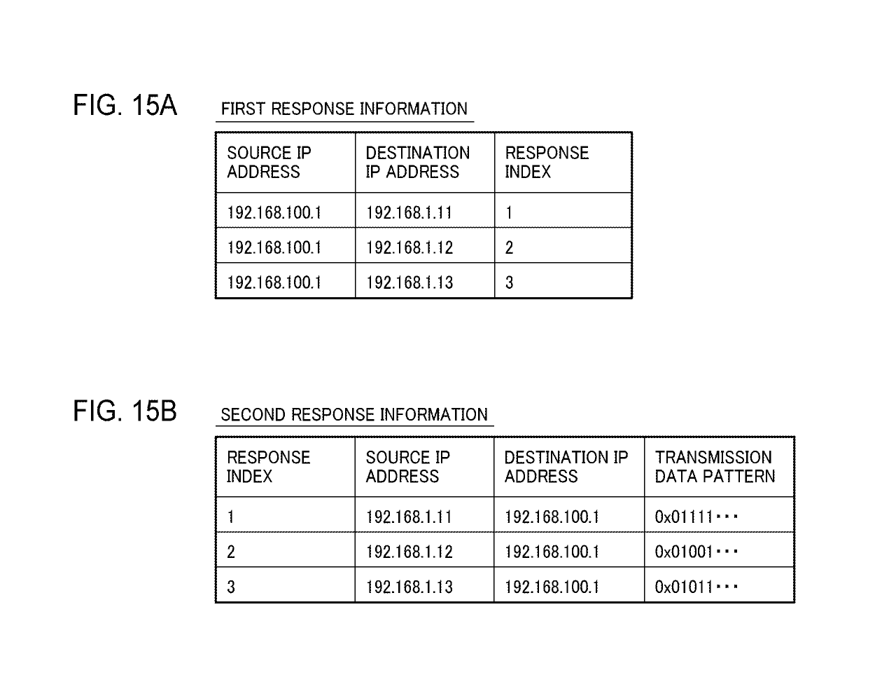

FIGS. 15A and 15B are diagrams for describing a specific example of the response information according to the first embodiment. In the example of FIGS. 15A and 15B, it is assumed that the response information includes first response information for matching the IP packet received by the packet receiving unit 2321 and second response information for specifying the content of a response to be transmitted to the virtual machine 23.

FIG. 15A is a diagram for describing a specific example of the first response information. The first response information illustrated in FIG. 15A includes a “source IP address” and a “destination IP address” for specifying an IP packet used for transmitting a response to the communication control device 231. Moreover, the first response information illustrated in FIG. 15A includes a “response index” for specifying the content of a response to be transmitted to the communication control device 231. Specifically, in the first response information illustrated in FIG. 15A, the “source IP address” is “192.168.100.1”, the “destination IP address” is “192.168.1.11”, and the response index is set to “1”. The description of the other information in FIG. 15A will not be provided.

FIG. 15B is a diagram for describing a specific example of the second response information. The second response information illustrated in FIG. 15B includes a “response index” for correlation with the information included in the first response information and the “source IP address” and “destination IP address” described in FIG. 15A. Moreover, the second response information illustrated in FIG. 15B includes a “transmission data pattern” which is a data pattern of the IP packet to be transmitted to the virtual machine 23. Specifically, in the second response information illustrated in FIG. 15B, “1” is set as the “response index”, “192.168.1.11” is set as the “source IP address”, and “192.168.100.1” is set as the “destination IP address”. Moreover, in the second response information illustrated in FIG. 15B, “0x01111 . . . ” is set as the “transmission data pattern”. The description of the other information in FIG. 15B will not be provided.

That is, in S32 of FIG. 11, the packet transmitting unit 2322 extracts the source IP address and the destination IP address from the IP header of the IP packet received by the packet receiving unit 2321. Moreover, the packet transmitting unit 2322 specifies information including the extracted source IP address and destination IP address from the first response information and extracts a response index included in the specified information. Specifically, in the example illustrated in FIG. 15A, when the source IP address of the received IP packet is “192.168.100.1” and the destination IP address is “192.168.1.12”, the packet transmitting unit 2322 specifies “2” as the “response index”.

Subsequently, the packet transmitting unit 2322 specifies information including the extracted response index from the second response information. In this way, the packet transmitting unit 2322 can specify the “transmission data pattern” which is the data set to a payload portion of the IP packet transmitted to the communication control device 231. Moreover, the packet transmitting unit 2322 transmits the IP packet by setting the source IP address included in the specified information to the source IP address and setting the destination IP address included in the specified information to the destination IP address.

Specifically, in the example illustrated in FIGS. 15A and 15B, when the packet transmitting unit 2322 specifies “2” as the response index, the packet transmitting unit 2322 specifies information of which the response index is “2” from the second response information. Moreover, the packet transmitting unit 2322 transmits an IP packet in which the source IP address is “192.168.1.12”, the destination IP address is “192.168.100.1”, and the payload portion is “0x01001 . . . ” to the virtual machine 23.

In this way, the responding device 232 can allow the virtual machine 23 to determine that a session between the virtual machine 23 and the client device 1 has been established.

[Tunnel Setting] The service provider may set the communication control device 231 and the responding device 232 so as to perform tunnel communication using the communication control device 231 as a starting point and the responding device 232 as a terminating point. Moreover, the communication control device 231 may transmit the IP packet to the responding device 232 using the tunnel communication. Similarly, the responding device 232 may transmit the IP packet to the communication control device 231 using the tunnel communication.

That is, the IP address of the client device 1 is set to the destination IP address of the IP header of the IP packet that the virtual machine 23 transmits to the client device 1. Thus, the communication control device 231 cannot transmit the IP packet transmitted from the virtual machine 23 to the client device 1 to the responding device 232 as it was.

Thus, upon receiving the IP packet received from the virtual machine 23, the communication control device 231 encapsulates the received IP packet. Subsequently, the communication control device 231 appends, to the encapsulated IP packet, a tunneling IP header in which the tunneling IP address of the communication control device 231 is used as a source IP address and a tunneling IP address of the responding device 232 is used as a destination IP address. In this way, the communication control device 231 can transmit the IP packet transmitted from the virtual machine 23 to the client device 1 to the responding device 232.

Moreover, the responding device 232 having received the tunneling IP packet from the communication control device 231 removes the tunneling IP header from the received tunneling IP packet. In this way, the responding device 232 can acquire the IP packet that the virtual machine 23 has transmitted to the client device 1 and perform a process for transmitting a response to the acquired IP packet to the communication control device 231.

When the responding device 232 transmits an IP packet to the communication control device 231 via a tunnel, the process of encapsulating the IP packet and appending a tunneling IP header is the same as that described above. Thus, the description thereof will not be provided.

### Second Embodiment

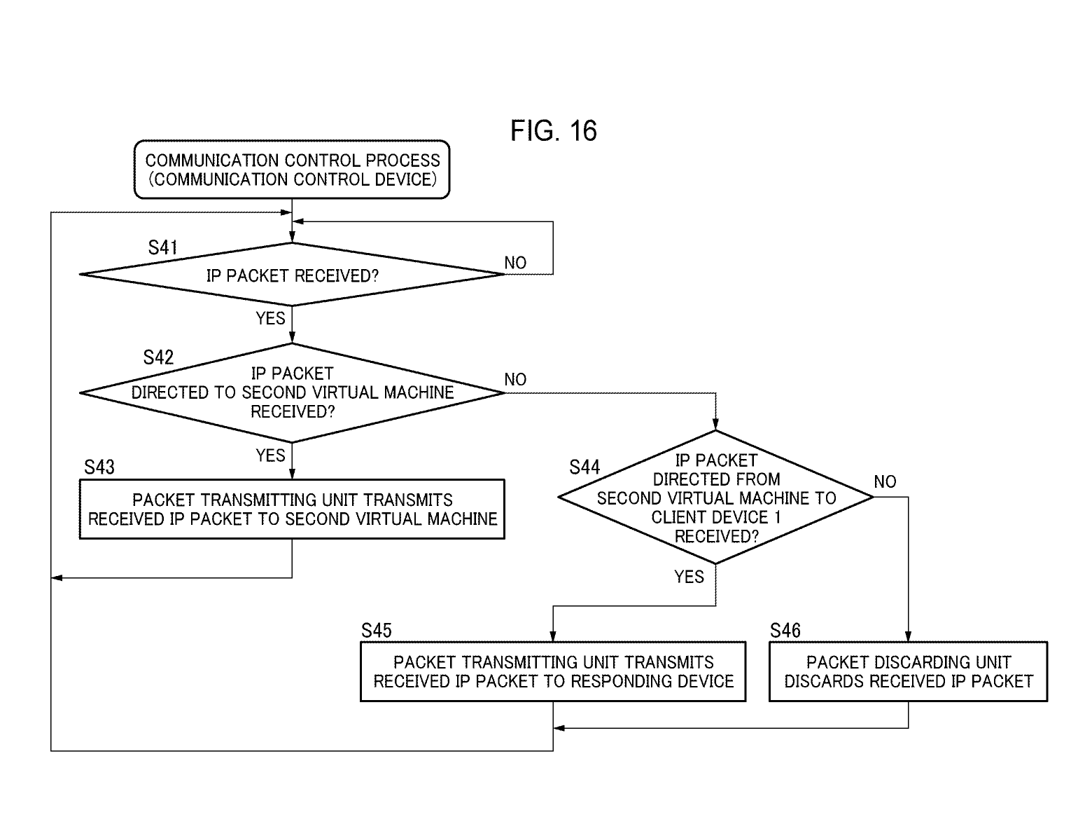

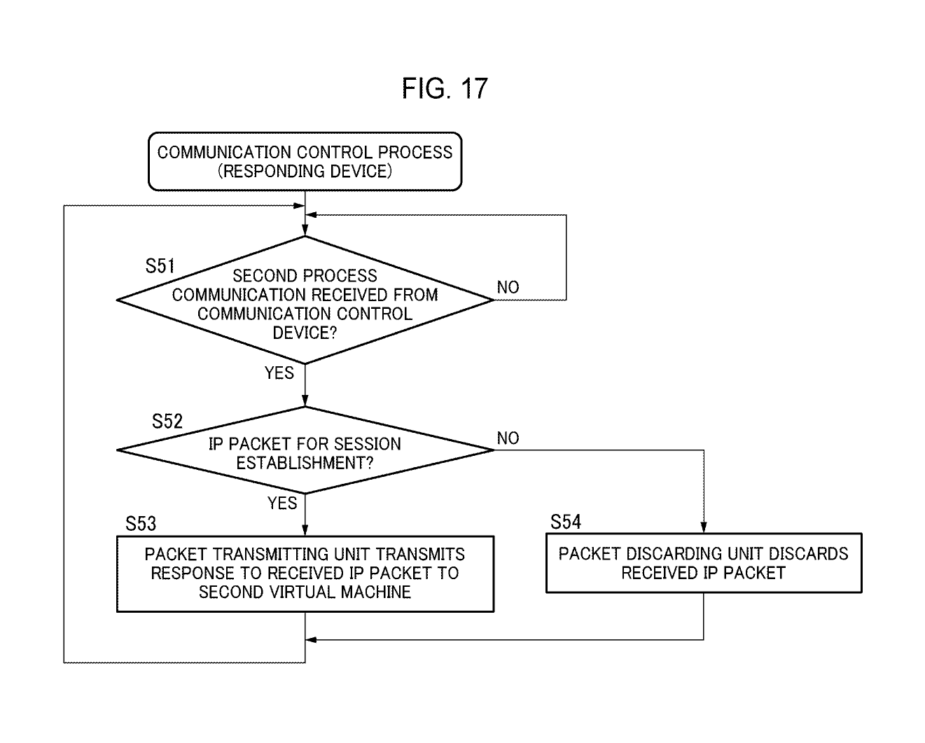

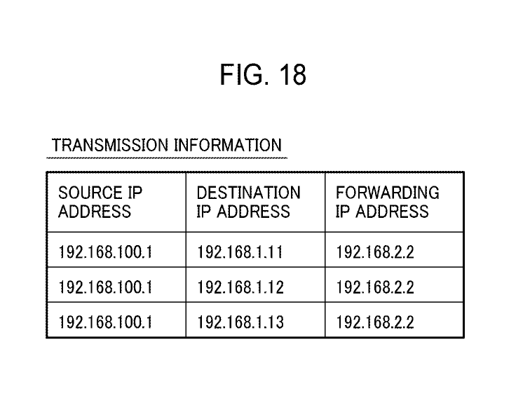

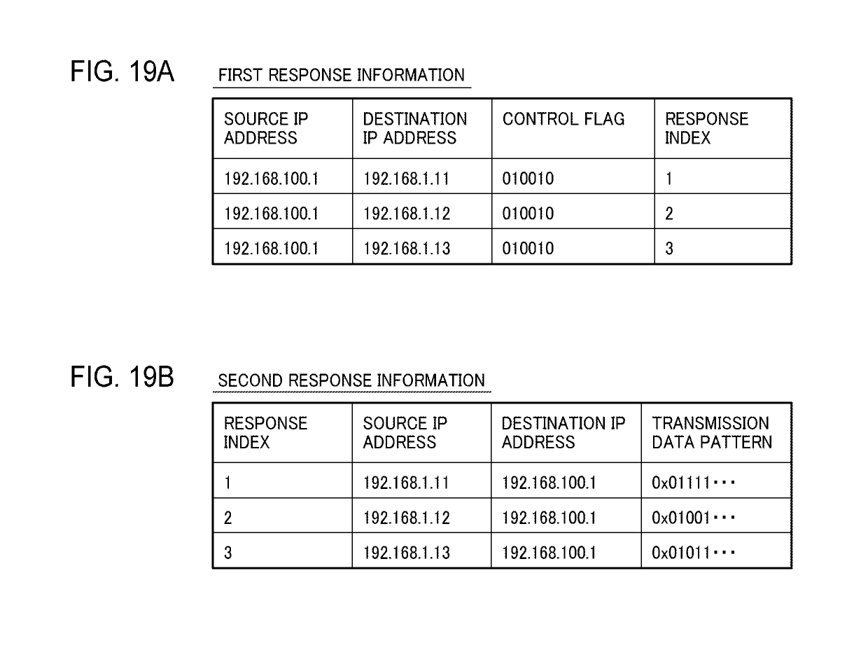

Next, a second embodiment will be described. FIGS. 16 and 17 are flowcharts for describing a communication control process according to the second embodiment. FIGS. 18 and 19 are diagrams for describing the communication control process according to the second embodiment.

In the second embodiment, unlike the first embodiment, the responding device 232 performs matching on the control flag included in the TCP header of the IP packet. That is, the communication control device 231 may be unable to perform matching on the control flag included in the TCP header due to reasons such as insufficient processing performance of the communication control device 231, for instance. In this case, the communication control device 231 transmits an IP packet for which transmission of a response to the virtual machine 23 to the responding device 232 is not originally needed. Thus, in the second embodiment, the responding device 232 also performs matching on the information included in the IP packet.

[Process of Communication Control Device 231] First, the communication control process of the communication control device 231 will be described. FIG. 16 is a flowchart illustrating the details of the communication control process of the communication control device 231.

Similarly to the first embodiment, the packet receiving unit 2311 of the communication control device 231 performs standby until the packet receiving unit 2311 receives an IP packet from a device or the like that can access the communication control device 231, for instance (S41: NO). When the IP packet is received (S41: YES), the packet receiving unit 2311 determines whether the received IP packet is an IP packet transmitted to the virtual machine 23, for instance (S42).

When the received IP packet is the IP packet transmitted to the virtual machine 23 (S42: YES), the packet transmitting unit 2312 transmits the received IP packet to the virtual machine 23, for instance (S43). On the other hand, when the received IP packet is not the IP packet transmitted from the virtual machine 23 (S42: NO), the relay determining unit 2313 determines whether the received IP packet is the IP packet transmitted from the virtual machine 23 to the client device 1, for instance (S44).

When the received IP packet is the IP packet transmitted from the virtual machine 23 to the client device 1 (S44: YES), the packet transmitting unit 2312 transmits the received IP packet to the responding device 232, for instance (S45). That is, unlike the communication control device 231 of the first embodiment, the communication control device 231 of the second embodiment transmits the received IP packet to the responding device 232 without determining whether the received IP packet is an IP packet used for establishing a session.

On the other hand, when the received IP packet is not the IP packet transmitted from the virtual machine 23 to the client device 1 (S44: NO), the packet discarding unit 2314 discards the IP packet received by the packet receiving unit 2311, for instance (S46).

FIG. 18 is a diagram for describing a specific example of the transmission information according to the second embodiment. Unlike the transmission information described in FIG. 12, the transmission information illustrated in FIG. 18 includes a “source IP address”, a “destination IP address”, and an “forwarding IP address” only. Specifically, in the transmission information illustrated in FIG. 18, for instance, “192.168.100.1” is set as the “source IP address”, “192.168.1.11” is set as the “destination IP address”, and “192.168.2.2” is set as the “forwarding IP address”. The description of the other information in FIG. 18 will not be provided.

That is, the communication control device 231 according to the second embodiment does not determine whether the received IP packet is an IP packet used for establishing a session. Thus, the unlike the transmission information illustrated in FIG. 12, the transmission information illustrated in FIG. 18 does not include the “control flag”.

[Process of Responding Device 232] Next, the communication control process of the responding device 232 will be described. FIG. 17 is a flowchart illustrating the details of the communication control process of the responding device 232.

First, similarly to the first embodiment, the packet receiving unit 2321 of the responding device 232 performs standby until the packet receiving unit 2321 receives an IP packet from the communication control device 231, for instance (S51: NO). When the IP packet is received (S51: YES), the response determining unit 2323 of the responding device 232 determines whether the received IP packet is an IP packet used for establishing a session (S52).

That is, the communication control device 231 of the second embodiment does not determine whether the received IP packet is an IP packet used for establishing a session. Moreover, the communication control device 231 of the second embodiment transmits all IP packets of which the source is the virtual machine 23 and the destination is the client device 1 to the responding device 232. Thus, unlike the first embodiment, the responding device 232 of the second embodiment determines whether the received IP packet is an IP packet used for establishing a session.

When the received IP packet is an IP packet used for establishing a session (S52: YES), the packet transmitting unit 2322 of the responding device 232 transmits a response to the received IP packet to the virtual machine 23, for instance (S53). That is, when the received IP packet is an IP packet used for requesting establishment of a session, the IP packet is a SYN/ACK packet that the virtual machine 23 transmitted to the client device 1 to issue a request for session establishment. Thus, in this case, the packet transmitting unit 2322 transmits an ACK packet which is a response to the SYN/ACK packet to the virtual machine 23.

On the other hand, when the received IP packet is not the IP packet used for establishing a session (S52: NO), the packet discarding unit 2324 discards the IP packet received by the packet receiving unit 2321, for instance (S54). That is, unlike the responding device 232 of the first embodiment, the responding device 232 of the second embodiment discards the IP packet when the received IP packet is not the IP packet used for establishing a session. A specific example of the response information according to the second embodiment will be described below.

FIGS. 19A and 19B are diagrams for describing a specific example of the response information according to the second embodiment. In the example of FIGS. 19A and 19B, it is assumed that the response information includes first response information for matching the IP packet received by the packet receiving unit 2321 and second response information for specifying the content of a response to be transmitted to the virtual machine 23.

FIG. 19A is a diagram for describing a specific example of the first response information. The first response information illustrated in FIG. 19A includes a “control flag” in addition to the information included in the first response information described in FIG. 15A. Specifically, in the first response information illustrated in FIG. 19A, “192.168.100.1” is set as the “source IP address”, “192.168.1.11” is set as the “destination IP address”, and “1” is set as the “response index”. Further, in the first response information illustrated in FIG. 19A, “010010” is set as the “control flag”. The description of the other information in FIG. 19A will not be provided. In this way, the responding device 232 can determine whether the received IP packet is the IP packet used for establishing a session.

FIG. 19B is a diagram for describing a specific example of the second response information. The second response information illustrated in FIG. 19B include the same information as the second response information described in FIG. 15B. Specifically, in the second response information illustrated in FIG. 19B, “1” is set as the “response index”, “192.168.1.11” is set as the “source IP address”, and “192.168.100.1” is set as the “destination IP address”. Moreover, in the second response information illustrated in FIG. 19B, “0x01111 . . . ” is set as the “transmission data pattern”. The description of the other information in FIG. 19B will not be provided.

As described above, in the second embodiment, both the communication control device 231 and the responding device 232 perform matching on the information included in the IP packet. In this way, the communication control device 231 can perform the communication control process even when the communication control device 231 is unable to perform matching on the control flag due to reasons such as insufficient processing performance of the communication control device 231, for instance.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a communication control device that receives an input of first process communication from a first information processing device and controls internal and external communication with a second information processing device; and
a responding device that can communicate with the communication control device, wherein
upon receiving the first process communication, the communication control device transmits the received first process communication to the second information processing device, and
upon receiving second process communication, which is a response to the first process communication transmitted from the second information processing device to the first information processing device, the communication control device transmits the second process communication to the responding device by changing a destination of the second process communication from the first information processing device to the responding device.

2. The information processing system according to claim 1, wherein
the communication control device determines whether the received second process communication is to be transmitted to the responding device or be discarded, based on a content of the received second process communication.

3. The information processing system according to claim 1, wherein
upon receiving the second process communication from the communication control device, the responding device transmits a response to the received second process communication to the communication control when the received second process communication is a session establishment request directed from the second information processing device to the first information processing device, and
upon receiving from the responding device a response to the second process communication, the communication control device transmits a response to the second process communication to the second information processing device.

4. The information processing system according to claim 1, wherein
the communication control device transmits the received second process communication to the responding device, using tunnel communication which uses the communication control device as a starting point and the responding device as a terminating point.

5. A non-transitory computer-readable storage medium storing therein a control program for causing a computer to execute a process comprising:
upon receiving the first process communication, transmitting, by a communication control device that receives an input of first process communication from a first information processing device and controls internal and external communication with a second information processing device, the received first process communication to the second information processing device, communication control device being able to communicate with a responding device, and
upon receiving second process communication, which is a response to the first process communication transmitted from the second information processing device to the first information processing device, transmitting, by the communication control device, the second process communication to the responding device by changing a destination of the second process communication from the first information processing device to the responding device.

6. An information processing system comprising:
a communication control device that receives an input of first process communication from a first information processing device and controls internal and external communication with a second information processing device;
a responding device that can communicate with the communication control device; and
a physical switch device that controls communication between the first information processing device and a third information processing device, wherein
upon receiving the first process communication directed from the first information processing device to the third information processing device, the physical switch device transmits the received first process communication to the third information processing device and transmits the first process communication to the second information processing device via the communication control device,
upon receiving the first process communication, the communication control device transmits the received first process communication to the second information processing device, and
upon receiving second process communication which is a response to the first process communication transmitted from the second information processing device to the first information processing device, the communication control device transmits the second process communication to the responding device by changing a destination of the second process communication from the first information processing device to the responding device.

7. The information processing system according to claim 6, wherein
upon receiving the first process communication from the first information processing device in a normal operation mode, the third information processing device executes a process corresponding to the received first process communication,
upon receiving the first process communication from the first information processing device in the event of an abnormality in the third information processing device, the second information processing device executes the process corresponding to the received first process communication in place of the third information processing device,
upon receiving the second process communication from the second information processing device in the event of an abnormality in the third information processing device, the communication control device transmits the received second process communication to the first information processing device.

8. A control method comprising:
upon receiving the first process communication, transmitting, by a communication control device that receives an input of first process communication from a first information processing device and controls internal and external communication with a second information processing device, the received first process communication to the second information processing device, communication control device being able to communicate with a responding device, and
upon receiving second process communication, which is a response to the first process communication transmitted from the second information processing device to the first information processing device, transmitting, by the communication control device, the second process communication to the responding device by changing a destination of the second process communication from the first information processing device to the responding device.
